(19) United States
(12) Patent Application Publication
(10) Pub. No.: US 2025/0266645 A1
(43) Pub. Date: Aug. 21, 2025

(54) STRAP CONNECTOR AND ASSEMBLY THEREOF WITH ENHANCED MATING RETENTION FORCE

(71) Applicant: Luxshare Technologies International, Inc., MILPITAS, CA (US)

(72) Inventors: Hengshan CHENG, MILPITAS, CA (US); Hongji CHEN, MILPITAS, CA (US); Yiheng LIN, MILPITAS, CA (US)

(73) Assignee: Luxshare Technologies International, Inc., MILPITAS, CA (US)

(21) Appl. No.: 19/200,022

(22) Filed: May 6, 2025

Related U.S. Application Data
(63) Continuation of application No. 17/834,523, filed on Jun. 7, 2022, now Pat. No. 12,322,901.

(30) Foreign Application Priority Data
Jun. 16, 2021 (CN) 202110665729.0

(51) Int. Cl. H01R 13/631; H01R 13/514; H01R 13/627

(52) U.S. Cl. CPC H01R 13/631; H01R 13/514; H01R 13/6275

(57) ABSTRACT

A strap connector includes an insulating body, a number of conductive terminals, a movable component having a first locking protrusion, a second locking protrusion, and a pull strap. The pull strap is connected with the movable component. The first locking protrusion and the second locking protrusion are adapted to lock with a first locking hole and a second locking hole of a mating connector, respectively, thereby improving the mating retention force when mating with the mating connector. A strap connector assembly having the strap connector is also disclosed.

### CROSS-REFERENCE TO RELATED APPLICATIONS

This application is a continuation of U.S. patent application Ser. No. 17/834,523, filed on Jun. 7, 2022, which claims priority of a Chinese Patent Application No. 202110665729.0, filed on Jun. 16, 2021 and titled “STRAP CONNECTOR AND ASSEMBLY THEREOF”, the entire content of which is incorporated herein by reference.

### TECHNICAL FIELD

The present disclosure relates to a strap connector and an assembly thereof, which belongs to a technical field of connectors.

### BACKGROUND

An existing strap connector assembly usually includes a strap connector and a mating connector. The strap connector includes an insulating body, a plurality of conductive terminals, a locking piece located on one side of the insulating body, and a pull strap connected with the locking piece. The locking piece is provided with a locking protrusion on one side of the insulating body. The mating connector is provided with a locking slot matched with the locking protrusion.

However, the single-sided locking features in the prior art have a weak holding force when the strap connector and the mating connector are mated with each other, and are likely to affect data transmission due to looseness.

### SUMMARY

In order to achieve the above object, the present disclosure adopts the following technical solution: a strap connector, including: an insulating body, the insulating body including a first side surface, a second side surface, and a mating interface between the first side surface and the second side surface, the mating interface being configured to mate with a mating connector; a plurality of conductive terminals, each conductive terminal including a mating portion positioned to the mating interface; a movable component, the movable component including at least one first locking protrusion disposed on a same side with the first side surface, the at least one first locking protrusion protruding beyond the first side surface; at least one second locking protrusion disposed on a same side with the second side surface, the at least one second locking protrusion protruding beyond the second side surface; and a pull strap, the pull strap being connected with the movable component; wherein the at least one first locking protrusion and the at least one second locking protrusion are lockable with at least one first locking hole and at least one second locking hole of the mating connector, respectively.

In order to achieve the above object, the present disclosure adopts the following technical solution: a strap connector assembly, including: a strap connector, the strap connector including: an insulating body, the insulating body including a first side surface, a second side surface, and a mating interface between the first side surface and the second side surface; a plurality of conductive terminals, each conductive terminal including a mating portion positioned to the mating interface; a movable component, the movable component including at least one first locking protrusion disposed on a same side with the first side surface, the at least one first locking protrusion protruding beyond the first side surface; at least one second locking protrusion disposed on a same side with the second side surface, the at least one second locking protrusion protruding beyond the second side surface; and a pull strap, the pull strap being connected with the movable component; and a mating connector, the mating connector being configured to mate with the mating interface of the strap connector; the mating connector including: a mating insulating body; a plurality of mating terminals positioned to the mating insulating body, the plurality of mating terminals being configured to mate with the plurality of conductive terminals for electrical connection; and a metal shell enclosing the mating insulating body, the metal shell including a first side wall and a second side wall disposed opposite to the first side wall; the first side wall defining at least one first locking hole; the second side wall defining at least one second locking hole; wherein the at least one first locking protrusion and the at least one second locking protrusion are lockable with the at least one first locking hole and the at least one second locking hole of the mating connector, respectively.

In order to achieve the above object, the present disclosure adopts the following technical solution: a strap connector assembly, including: a strap connector, the strap connector including: an insulating body, the insulating body including a first side surface and a second side surface disposed opposite to the first side surface; a plurality of conductive terminals, the plurality of conductive terminals being secured to the insulating body; a movable component, the movable component including two first locking protrusions disposed on a same side with the first side surface, the two first locking protrusions protruding beyond the first side surface along a second direction; two second locking protrusions disposed on a same side with the second side surface, the two second locking protrusions protruding beyond the second side surface along a third direction; the second direction extending oppositely with respect to the third direction; and a pull strap, the pull strap being connected with the movable component; and a mating connector, the mating connector being configured to mate with the strap connector along a first direction; the second direction and the third direction being perpendicular to the first direction; the mating connector including: a mating insulating body; a plurality of mating terminals, the plurality of mating terminals being secured to the mating insulating body, the plurality of mating terminals being configured to mate with the plurality of conductive terminals for electrical connection; and a metal shell, the metal shell enclosing the mating insulating body, the metal shell including a first side wall, a second side wall disposed opposite to the first side wall, a first connecting wall connecting one side of the first side wall and one side of the second side wall, and a second connecting wall connecting another side of the first side wall and another side of the second side wall; the first side wall defining two first locking holes; the second side wall defining two second locking holes; wherein the two first locking protrusions and the two second locking protrusions are lockable with the two first locking holes and the two second locking holes of the mating connector, respectively.

### BRIEF DESCRIPTION OF DRAWINGS

FIG. 1 is a perspective schematic view of a strap connector assembly in accordance with an embodiment of the present disclosure, in which a strap connector is mating with a mating connector, and the mating connector is mounted to a circuit board;

FIG. 2 is a perspective schematic view of FIG. 1 from another angle;

FIG. 3 is a rear view of FIG. 1;

FIG. 4 is a partially exploded perspective view of FIG. 1;

FIG. 5 is a partially exploded perspective view of FIG. 4 from another angle;

FIG. 6 is a right side view of the strap connector assembly in FIG. 4 after removing the circuit board;

FIG. 7 is a further perspective exploded view of the strap connector assembly of the present disclosure;

FIG. 8 is a further perspective exploded view of the strap connector in FIG. 7;

FIG. 9 is a further perspective exploded view of the strap connector in FIG. 8;

FIG. 10 is a top view of the strap connector in FIG. 4;

FIG. 11 is a schematic cross-sectional view taken along line A-A in FIG. 6; and

FIG. 12 is a further perspective exploded view of the mating connector in FIG. 7.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

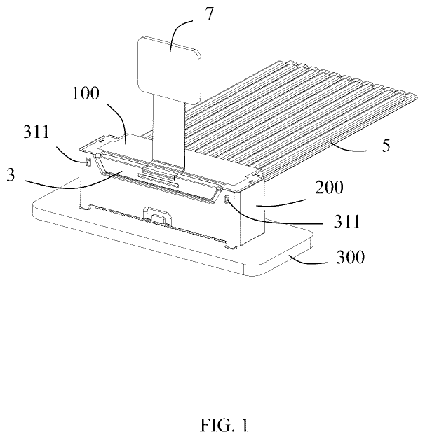

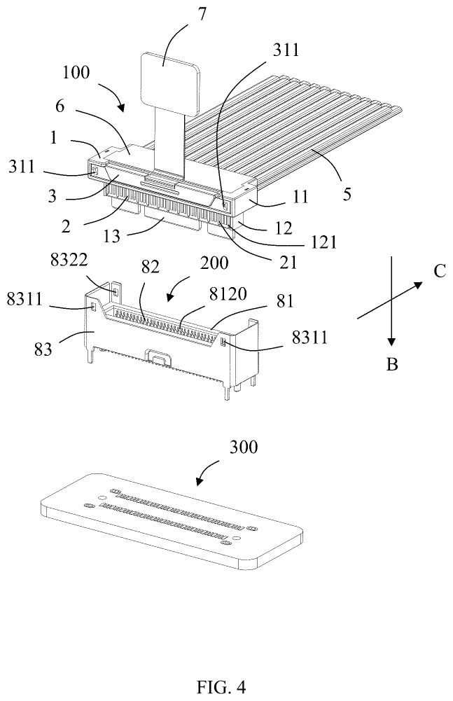

Referring to FIGS. 1 to 6, the present disclosure discloses a strap connector assembly including a strap connector 100 and a mating connector 200 for mating with the strap connector 100. In an illustrated embodiment of the present disclosure, the strap connector 100 is a cable connector, and the mating connector 200 is a board-end connector for being mounted to a circuit board 300. Referring to FIG. 4, the strap connector 100 is adapted to mate with the mating connector 200 along a mating direction B (i.e., a top-to-bottom direction) to realize data transmission.

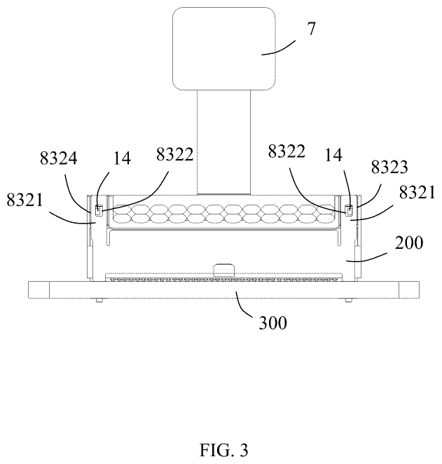

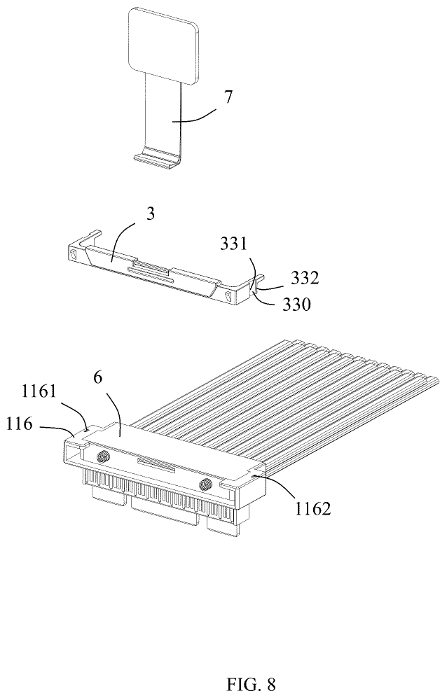

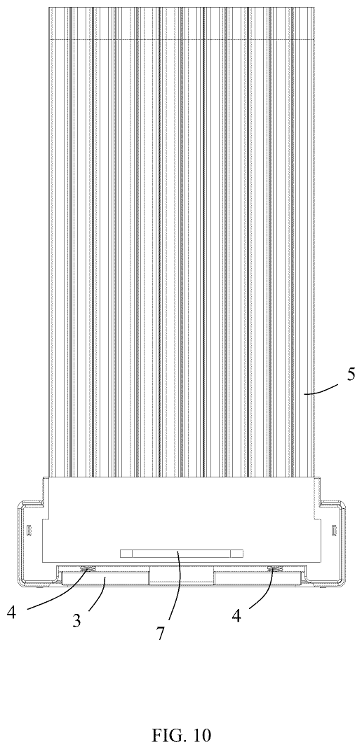

Referring to FIGS. 3 to 11, the strap connector 100 includes an insulating body 1, a plurality of conductive terminals 2 fixed to the insulating body 1, a movable component 3 installed in the insulating body 1, an elastic member 4 to abut against the movable component 3, a cable 5 electrically connected to the conductive terminals 2, a cover plate 6 fixed to the insulating body 1 and at least partially abutting against the cable 5, and a pull strap 7 connected to the movable component 3. The pull strap 7 is configured to drive the movable component 3 to overcome a force of the elastic member 4, so that the movable component 3 moves along a moving direction C perpendicular to a mating direction B (referring to FIG. 3).

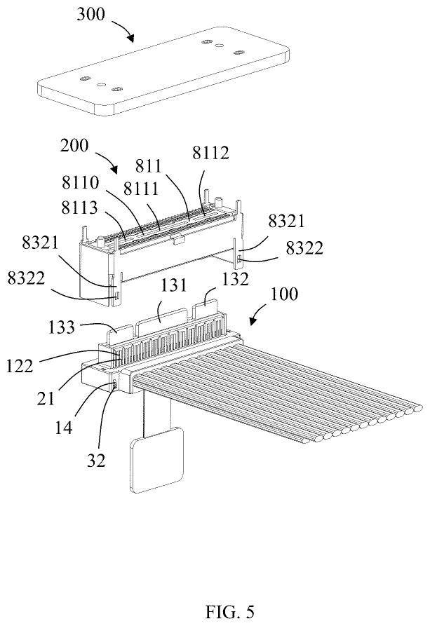

In the illustrated embodiment of the present disclosure, the insulating body 1 includes a main body portion 11, a tongue plate 12 protruding downwardly beyond the main body portion 11 along the mating direction B, and a positioning plate 13 further protruding downwardly beyond the tongue plate 12 along the mating direction B. In the illustrated embodiment of the present disclosure, a size of the main body portion 11 in a front-rear direction, a size of the tongue plate 12 in the front-rear direction, and a size of the positioning plate 13 in the front-rear direction become smaller in sequence, so that the insulating body 1 is of a roughly stepped configuration. In the illustrated embodiment of the present disclosure, referring to FIGS. 4 and 5, the positioning plate 13 includes a first positioning piece 131 located in the middle, a second positioning piece 132 located on one side of the first positioning piece 131 and spaced apart from the first positioning piece 131, and a third positioning piece 133 located on the other side of the first positioning piece 131 and spaced apart from the first positioning piece 131. A size of the first positioning piece 131 in the left-right direction is larger than a size of the second positioning piece 132 in the left-right direction. A size of the first positioning piece 131 in the left-right direction is also larger than a size of the third positioning piece 133 in the left-right direction. In the illustrated embodiment of the present disclosure, a distance between the first positioning piece 131 and the second positioning piece 132 is different from a distance between the first positioning piece 131 and the third positioning piece 133. This arrangement can play a role in preventing foolishness and prevent the strap connector 100 from being inserted into the mating connector 200 at a wrong angle.

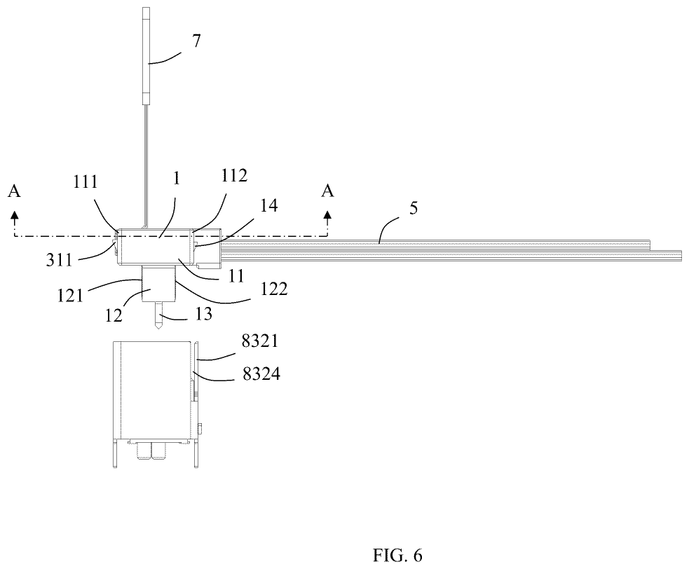

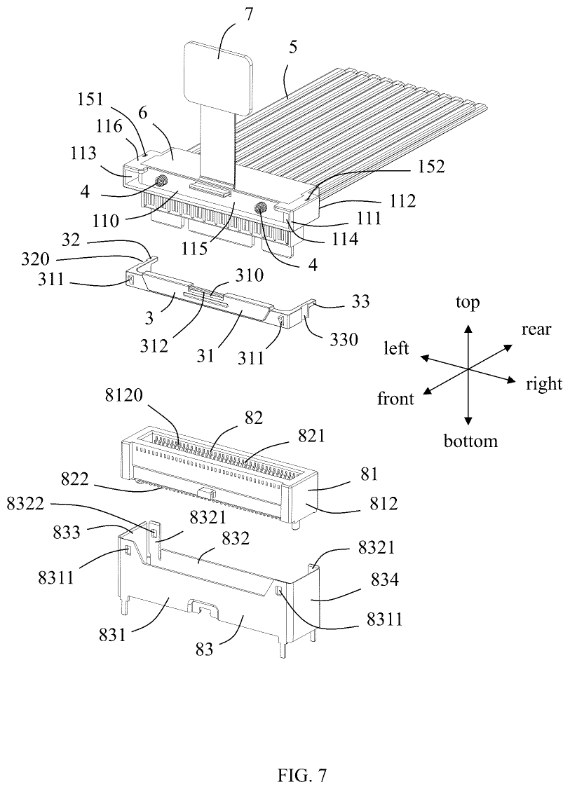

Referring to FIGS. 6 and 7, the main body portion 11 includes a first end wall 111 (i.e., a front end wall), a second end wall 112 (i.e., a rear end wall) opposite to the first end wall 111, a receiving space 110 extending forwardly through the first end wall 111, a first receiving groove 113 located on one side (i.e., a left side) of the receiving space 110, and a second receiving groove 114 located on the other side (i.e., a right side) of the receiving space 110. The receiving space 110 does not extend backwardly through the second end wall 112. The main body portion 11 includes an inner wall surface 115 exposed to the receiving space 110. The first receiving groove 113 and the second receiving groove 114 extend through the second end wall 112 along the moving direction C.

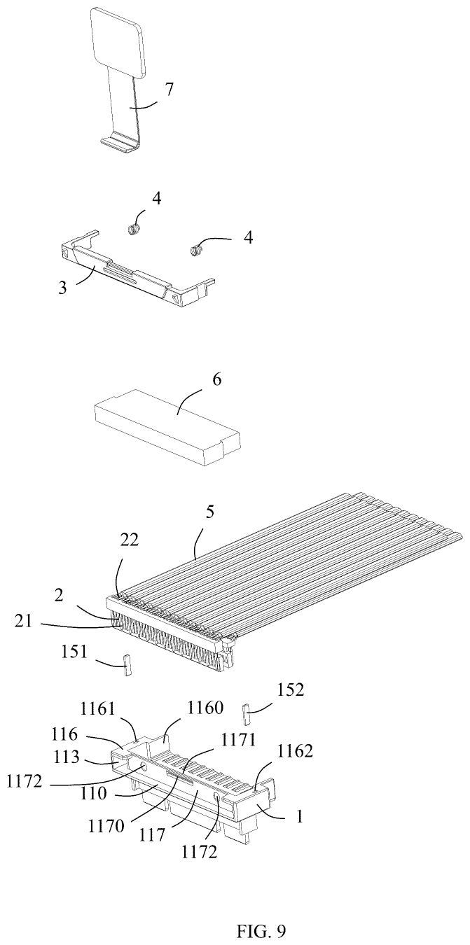

Besides, as shown in FIG. 9, the main body portion 11 also includes a top surface 116, an opening 1160 extending upwardly through the top surface 116, a first mounting hole 1161 extending upwardly through the top surface 116 and located on one side of the opening 1160, and a second mounting hole 1162 extending upwardly through the top surface 116 and located on the other side of the opening 1160. The main body portion 11 further includes a fixing plate 117 located between the first end wall 111 and the second end wall 112. In the illustrated embodiment of the present disclosure, the fixing plate 117 is a vertical plate. The fixing plate 117 includes a strap groove 1170 extending through the fixing plate 117 along the moving direction C and a strap shaft 1171 located between an edge (i.e., an upper edge) of the fixing plate 117 and the strap groove 1170. The pull strap 7 extends through the strap groove 1170 along the moving direction C from a position where it is connected with the movable component 3. The pull strap 7 is bent around the strap shaft 1171 and then extends beyond the main body portion 11. The fixing plate 117 further includes a receiving hole 1172. In the illustrated embodiment of the present disclosure, two receiving holes 1172 are provided. The receiving holes 1172 are recessed on a surface of the fixing plate 117 facing the movable component 3. That is, the receiving holes 1172 are exposed on the surface of the fixing plate 117 facing the movable component 3. One end of the elastic member 4 is disposed in the corresponding receiving hole 1172, and the other end of the elastic member 4 abuts against the movable component 3.

Referring to FIGS. 4 to 6, the tongue plate 12 includes a first surface 121 and a second surface 122 opposite to each other.

Each conductive terminal 2 includes a mating portion 21 exposed from the tongue plate 12 and a connection portion 22 electrically connected to the cable 5 (referring to FIG. 9). In the illustrated embodiment of the present disclosure, each mating portion 21 has a flat plate shape. The mating portions 21 of the conductive terminals 2 are exposed from the first surface 121 and the second surface 122, respectively. In an embodiment of the present disclosure, the conductive terminals 2 are insert-molded with the insulating body 1. Of course, in other embodiments, the conductive terminals 2 can also be directly assembled to the insulating body 1. Or, the conductive terminals 2 and an insulating block are combined to form a terminal module before being assembled to the insulating body 1. The fixing methods of the conductive terminals 2 and the insulating body 1 are well-known to those skilled in the art, which will not be repeated in the present disclosure.

In the illustrated embodiment of the present disclosure, the cable 5 extends beyond the main body portion 11 along the moving direction C.

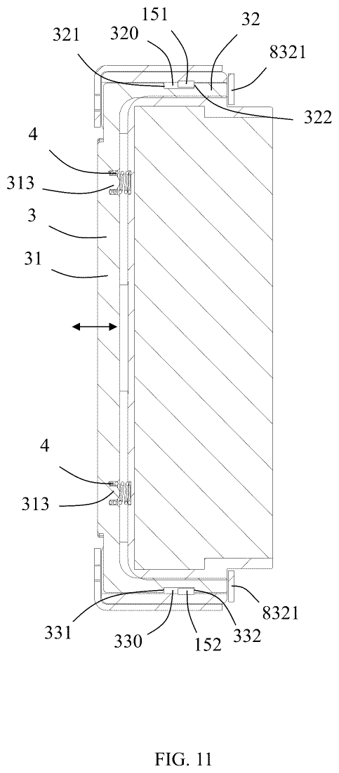

Referring to FIGS. 7 and 11, the movable component 3 is at least partially installed in the main body portion 11. Specifically, the movable component 3 includes a base portion 31 received in the receiving space 110, a first ejector rod 32 extending from one side of the base portion 31 and received in the first receiving groove 113, and a second ejector rod 33 extending from the other side of the base portion 31 and received in the second receiving groove 114.

The base portion 31 includes a first locking protrusion 311 protruding forwardly beyond the first end wall 111. In the illustrated embodiment of the present disclosure, two first locking protrusions 311 are provided, which are respectively located on opposite sides (i.e., a left side and a right side) of the base portion 31 so as to improve a mating retention force. In the illustrated embodiment of the present disclosure, the first locking protrusion 311 is integrally formed with the main body portion 11. Of course, in other embodiments, the first locking protrusion 311 can also be manufactured separately from the main body portion 11, and then assembled and fixed together. Under this circumstance, the first locking protrusion 311 may be made of a material different from that of the main body portion 11, for example, a wear-resistant material with better structural strength. The base portion 31 is also provided with a strap connection portion 312. The pull strap 7 is connected to the strap connection portion 312. The strap connection portion 312 includes a cutout 310 extending through the base portion along the moving direction C. The strap connection portion 312 is located above the cutout 310. The strap connection portion 312 is similar to a shaft portion, and is located between the cutout 310 and an edge (i.e., an upper edge) of the base portion 31. One end of the pull strap 7 passes through the through slot 310 and is sleeved around the pull strap connection portion 312.

In the illustrated embodiment of the present disclosure, the elastic member 4 is a compression spring installed between the base portion 31 and the inner wall surface 115 of the main body portion 11. In the illustrated embodiment of the present disclosure, two compression springs are provided and arranged side by side so as to improve the stability of the movable component 3 when moving. In addition, in order to better position the compression spring, the base portion 31 is further provided with a positioning post 313 (referring to FIG. 11) at least partially inserted into the compression spring.

The strap connector 100 includes a second locking protrusion 14 protruding backwardly beyond the second end wall 112. In the illustrated embodiment of the present disclosure, two second locking protrusions 14 are provided and located on opposite sides (i.e., a left side and a right side) of the second end wall 112 so as to improve the mating retention force. In the illustrated embodiment of the present disclosure, the second locking protrusion 14 and the main body portion 11 are integrally formed to save cost. Of course, in other embodiments, the second locking protrusion 14 can also be made separately from the main body portion 11, and then assembled and fixed together. Under this circumstance, the second locking protrusion 14 may be made of a material different from that of the main body portion 11. The first locking protrusion 311 and the second locking protrusion 14 are adapted to lock with locking holes of the mating connector 200 to improve the mating retention force, which will be described in detail later.

Referring to FIGS. 7, 8 and 11, the first ejector rod 32 includes a first groove 320, a first limiting surface 321 located at one end of the first groove 320 along the moving direction C, and a second limiting surface 322 located at the other end of the first groove 320 along the moving direction C. The first limiting surface 321 is closer to the first end wall 111 than the second limiting surface 322.

Similarly, the second ejector rod 33 includes a second groove 330, a third limiting surface 331 located at one end of the second groove 330 along the moving direction C, and a fourth limiting surface 332 located at the other end of the second groove 330 along the moving direction C. The third limiting surface 331 is closer to the first end wall 111 than the fourth limiting surface 332.

The strap connector 100 includes a first pin 151 and a second pin 152 fixed in the first mounting hole 1161 and the second mounting hole 1162, respectively. The first pin 151 is inserted into the first groove 320. The second pin 152 is inserted into the second groove 330. A size of the first groove 320 along the moving direction C is larger than a size of the first pin 151 along the moving direction C. A size of the second groove 330 along the moving direction C is greater than a size of the second pin 152 along the moving direction C. The first limiting surface 321 is adapted to abut against the first pin 151, and the third limiting surface 331 is adapted to abut against the second pin 152, so as to prevent the movable component 3 from moving excessively along the moving direction C under the action of the pull strap 7. The second limiting surface 322 is adapted to abut against the first pin 151, and the fourth limiting surface 332 is adapted to abut against the second pin 152, so as to prevent the movable component 3 from returning excessively along a direction opposite to the moving direction C when the clastic member 4 releases a restoring force.

The cover plate 6 is received and fixed in the opening 1160 of the main body portion 11. The pull strap 7 extends beyond the cover plate 6. In an embodiment of the present disclosure, the cover plate 6 presses against connection portions between the cable 5 and the conductive terminals 2 (i.e., soldering portions of the cable 5 and the conductive terminals 2) so as to play a protective role.

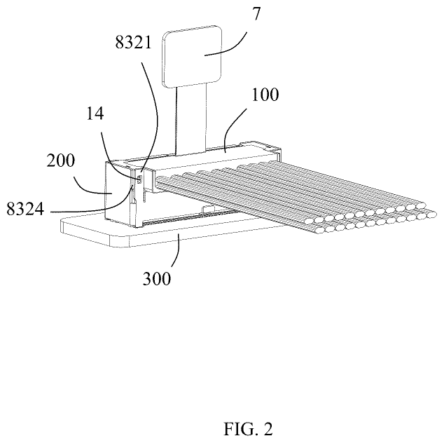

Referring to FIGS. 2 to 7 and 12, the mating connector 200 includes a mating insulating body 81, a plurality of mating terminals 82 fixed to the mating insulating body 81, and a metal shell 83 enclosing the mating insulating body 81. The mating insulating body 81 includes a bottom wall 811 and a plurality of side walls 812 perpendicular to the bottom wall 811. Referring to FIG. 5, the bottom wall 811 includes a positioning groove 8110 for receiving the positioning plate 13. Specifically, the positioning groove 8110 includes a first positioning groove 8111 accommodating the first positioning piece 131, a second positioning groove 8112 accommodating the second positioning piece 132, and a third positioning groove 8113 accommodating the third positioning piece 133. In the illustrated embodiment of the present disclosure, the first positioning groove 8111, the second positioning groove 8112 and the third positioning groove 8113 extend through the bottom wall 811.

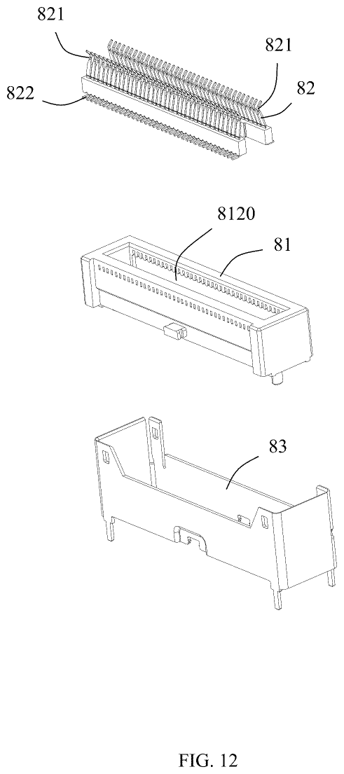

Referring to FIGS. 7 and 12, the side walls 812 are enclosed to form a mating slot 8120 for receiving the tongue plate 12. The mating terminals 82 are arranged in two rows. Each mating terminal 82 includes an clastic mating arm 821 and a mounting tail 822 for being mounted to the circuit board 300. The elastic mating arm 821 extends into the mating slot 8120 and is adapted to contact the mating portion 21.

The metal shell 83 includes a first side wall 831, a second side wall 832 disposed opposite to the first side wall 831, a first connecting wall 833 connecting one side of the first side wall 831 and one side of the second side wall 832, and a second connecting wall 834 connecting the other side of the first side wall 831 and the other side of the second side wall 832. The first side wall 831 is provided with a first locking hole 8311 which mates with the first locking protrusion 311. The second side wall 832 is provided with an clastic arm 8321. The clastic arm 8321 is provided with a second locking hole 8322 which mates with the second locking protrusion 14. In the illustrated embodiment of the present disclosure, the clastic arm 8321 is of a cantilevered configuration, which can be elastically deformed under the action of an external force, and return to a position after the external force is released. In the illustrated embodiment of the present disclosure, two elastic arms 8321 are provided and located on left and right sides of the second side wall 832, respectively. There is a first slot 8323 between the elastic arm 8321 close to the first connecting wall 833 and the first connecting wall 833. There is a second slot 8324 between the clastic arm 8321 close to the second connecting wall 834 and the second connecting wall 834 (referring to FIG. 3). By providing the first slot 8323 and the second slot 8324, the corresponding clastic arm 8321 has better clastic deformation ability.

When the strap connector 100 is inserted into the mating connector 200, the positioning plate 13 corresponds to the positioning groove 8110, the tongue plate 12 corresponds to the mating slot 8120, and the mating portions 21 of the conductive terminals 2 correspond to the clastic mating arms 821 of the mating terminals 82. With the insertion of the strap connector 100, inclined surfaces of the first locking protrusion 311 and the second locking protrusion 14 abut against the first side wall 831 and the second side wall 832, respectively. The movable component 3 overcomes the force of the clastic member 4 and shrinks inwardly along the moving direction C by a certain distance. When the first locking protrusion 311 and the second locking protrusion 14 move downwardly to correspond to the first locking hole 8311 and the second locking hole 8322, the clastic member 4 restores elasticity. This causes the movable component 3 return in a direction opposite to the moving direction C. At this time, the first locking protrusion 311 and the second locking protrusion 14 protrude forwardly and backwardly into the first locking hole 8311 and the second locking hole 8322, respectively to realize the locking of the strap connector 100 and the mating connector 200. Compared with the prior art, the present disclosure can realize double-sided locking by arranging the first locking protrusion 311 and the second locking protrusion 14 on both sides. Therefore, the mating retention force is improved, and the risk of loosening of the strap connector 100 and the mating connector 200 is reduced.

When unlocking is required, an external force is applied to pull the pull strap 7. The pull strap 7 generates a force component along the moving direction C. The component force in this direction overcomes the force of the elastic member 4 and causes the movable component 3 to move along the moving direction C. At this time, on one hand, the first locking protrusion 311 escapes from the first locking hole 8311; and on the other hand, the first ejector rod 32 and the second ejector rod 33 extend rightward and protrude beyond the second end wall 112 so as to push the corresponding elastic arms 8321 to deform outward, thereby causing the second locking protrusion 14 escape from the second locking hole 8322. In other words, at this time, the strap connector 100 and the mating connector 200 are unlocked on both sides. The strap connector 100 can be pulled out of the mating connector 200 by applying other forces or by an upward component force applied to the strap 7.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A strap connector, comprising:
an insulating body, the insulating body comprising a first side surface, a second side surface, and a mating interface between the first side surface and the second side surface, the mating interface being configured to mate with a mating connector;
a plurality of conductive terminals, each conductive terminal comprising a mating portion positioned to the mating interface;
a movable component, the movable component comprising at least one first locking protrusion disposed on a same side with the first side surface, the at least one first locking protrusion protruding beyond the first side surface;
at least one second locking protrusion disposed on a same side with the second side surface, the at least one second locking protrusion protruding beyond the second side surface; and
a pull strap, the pull strap being connected with the movable component;
wherein the at least one first locking protrusion and the at least one second locking protrusion are lockable with at least one first locking hole and at least one second locking hole of the mating connector, respectively.

2. The strap connector according to claim 1, wherein the second side surface is disposed opposite to the first side surface;
the mating interface is configured to mate with the mating connector along a first direction;
the at least one first locking protrusion protrudes beyond the first side surface along a second direction; the at least one second locking protrusion protrudes beyond the second side surface along a third direction, the second direction extends oppositely with respect to the third direction;
the second direction and the third direction are perpendicular to the first direction.

3. The strap connector according to claim 1, wherein the number of the at least one first locking protrusion is two, and the number of the at least one second locking protrusion is two;
the number of the at least one first locking hole is two, and the number of the at least one second locking hole is two;
the two first locking protrusions and the two second locking protrusions are lockable with the two first locking holes and the two second locking holes of the mating connector, respectively.

4. The strap connector according to claim 1, wherein the movable component comprises a strap slot and a strap connection portion disposed adjacent to the strap slot; the pull strap extends through the strap slot and is connected with the strap connection portion.

5. The strap connector according to claim 4, wherein the strap connection portion and the at least one first locking protrusion are integrally formed on the movable component.

6. The strap connector according to claim 1, further comprising at least one cable electrically connected to the plurality of conductive terminals.

7. The strap connector according to claim 1, wherein the mating interface comprises a tongue plate; the mating portion of each conductive terminal is rigid and exposed on the tongue plate.

8. The strap connector according to claim 1, wherein the movable component is at least partially installed in the insulating body, and the movable component is movable along a moving direction.

9. The strap connector according to claim 8, further comprising an elastic member abutting against the movable component.

10. A strap connector assembly, comprising:
a strap connector, the strap connector comprising:
an insulating body, the insulating body comprising a first side surface, a second side surface, and a mating interface between the first side surface and the second side surface;
a plurality of conductive terminals, each conductive terminal comprising a mating portion positioned to the mating interface;
a movable component, the movable component comprising at least one first locking protrusion disposed on a same side with the first side surface, the at least one first locking protrusion protruding beyond the first side surface;
at least one second locking protrusion disposed on a same side with the second side surface, the at least one second locking protrusion protruding beyond the second side surface; and
a pull strap, the pull strap being connected with the movable component; and
a mating connector, the mating connector being configured to mate with the mating interface of the strap connector; the mating connector comprising:
a mating insulating body;
a plurality of mating terminals positioned to the mating insulating body, the plurality of mating terminals being configured to mate with the plurality of conductive terminals for electrical connection; and
a metal shell enclosing the mating insulating body, the metal shell comprising a first side wall and a second side wall disposed opposite to the first side wall; the first side wall defining at least one first locking hole; the second side wall defining at least one second locking hole;
wherein the at least one first locking protrusion and the at least one second locking protrusion are lockable with the at least one first locking hole and the at least one second locking hole of the mating connector, respectively.

11. The strap connector assembly according to claim 10, wherein the mating connector is configured to mate with the mating interface of the strap connector along a first direction; the at least one first locking protrusion protrudes beyond the first side surface along a second direction;
the at least one second locking protrusion protrudes beyond the second side surface along a third direction, the second direction extends oppositely with respect to the third direction; the second direction and the third direction are perpendicular to the first direction.

12. The strap connector assembly according to claim 10, wherein the number of the at least one first locking protrusion is two, and the number of the at least one second locking protrusion is two;
the number of the at least one first locking hole is two, and the number of the at least one second locking hole is two;
the two first locking protrusions and the two second locking protrusions are lockable with the two first locking holes and the two second locking holes of the mating connector, respectively.

13. The strap connector assembly according to claim 10, wherein the movable component comprises a strap slot and a strap connection portion disposed adjacent to the strap slot; the pull strap extends through the strap slot and is connected with the strap connection portion.

14. The strap connector assembly according to claim 13, wherein the strap connection portion and the at least one first locking protrusion are integrally formed on the movable component.

15. The strap connector assembly according to claim 10, wherein the strap connector further comprises at least one cable electrically connected to the plurality of conductive terminals.

16. The strap connector assembly according to claim 10, wherein the mating interface comprises a tongue plate; the mating portion of each conductive terminal is rigid and exposed on the tongue plate.

17. The strap connector assembly according to claim 10, wherein the movable component is at least partially installed in the insulating body and the movable component is movable along a moving direction.

18. The strap connector assembly according to claim 17, wherein the strap connector further comprises an elastic member abutting against the movable component.

19. A strap connector assembly, comprising:
a strap connector, the strap connector comprising:
an insulating body, the insulating body comprising a first side surface and a second side surface disposed opposite to the first side surface;
a plurality of conductive terminals, the plurality of conductive terminals being secured to the insulating body;
a movable component, the movable component comprising two first locking protrusions disposed on a same side with the first side surface, the two first locking protrusions protruding beyond the first side surface along a second direction;
two second locking protrusions disposed on a same side with the second side surface, the two second locking protrusions protruding beyond the second side surface along a third direction; the second direction extending oppositely with respect to the third direction; and
a pull strap, the pull strap being connected with the movable component; and
a mating connector, the mating connector being configured to mate with the strap connector along a first direction; the second direction and the third direction being perpendicular to the first direction; the mating connector comprising:
a mating insulating body;
a plurality of mating terminals, the plurality of mating terminals being secured to the mating insulating body, the plurality of mating terminals being configured to mate with the plurality of conductive terminals for electrical connection; and
a metal shell, the metal shell enclosing the mating insulating body, the metal shell comprising a first side wall, a second side wall disposed opposite to the first side wall, a first connecting wall connecting one side of the first side wall and one side of the second side wall, and a second connecting wall connecting another side of the first side wall and another side of the second side wall; the first side wall defining two first locking holes; the second side wall defining two second locking holes;
wherein the two first locking protrusions and the two second locking protrusions are lockable with the two first locking holes and the two second locking holes of the mating connector, respectively.

20. The strap connector assembly according to claim 19, wherein the strap connector further comprises at least one cable electrically connected to the plurality of conductive terminals.
